(19) United States
(12) Patent Application Publication
(10) Pub. No.: US 2005/0094735 A1
(43) Pub. Date: May 5, 2005

(54) Interface for digital signals and power transmitted over a pair of wires

(76) Inventor: Richard D. Crawford, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/698,898

(22) Filed: Oct. 31, 2003

(51) Int. Cl. H04B 3/00

(52) U.S. Cl. 375/257

(57) ABSTRACT

An interface routes power and digital signals to a load. The interface includes a rectifier receiving the power and the digital signals over a single wire pair and producing rectified power and rectified digital signals, and a separator for separating the rectified power driving the load from the rectified digital signals controlling output of the load.

### BACKGROUND

Both universal serial bus (“USB”) and IEEE-1394 (Firewire) compliant connectors are capable of providing power and digital audio signals to peripheral devices such as speakers including amplifiers. However, USB and Firewire devices provide power and signals over separate, dedicated power and signal wire pairs.

The maximum “power” delivered by both USB and Firewire connectors is limited. USB delivers a maximum of 500 milliamps to the load; Firewire delivers a maximum of 1.5 Amps.

The wire pairs routing power and digital signals are not optimized for general speaker installations. For example, USB cables are relatively expensive, owing to their integral connectors. Moreover, they come in a limited number of fixed lengths. Thus, bridging a 25-foot gap between an audio source and a USB compliant speaker can be expensive. In addition, such long runs of USB cable often involve multiple connectors, e.g., two connectors for each section of USB extension cable, which increases the possibility of high resistance connections, shorts circuits, etc., in the 25-foot cable length.

### SUMMARY

According to one aspect of the present invention, an interface routes power and digital signals to a load. The interface includes a rectifier receiving the power and the digital signals over a single wire pair and producing rectified power and rectified digital signals, and a separator for separating the rectified power driving the load from the rectified digital signals controlling output of the load.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a high-level block diagram of a configuration according to an embodiment the present invention.

FIG. 2 is a high-level block diagram of another configuration according to an embodiment the present invention.

FIG. 3 is an illustration of another configuration according to an embodiment the present invention

FIG. 4 is an illustration of a system configuration according to an embodiment the present invention.

FIG. 5 is a schematic diagram depicting exemplary circuit elements for the system depicted in FIG. 4.

FIG. 6 is a high-level block diagram of a speaker system employing the configuration depicted in FIG. 3.

### DETAILED DESCRPTION

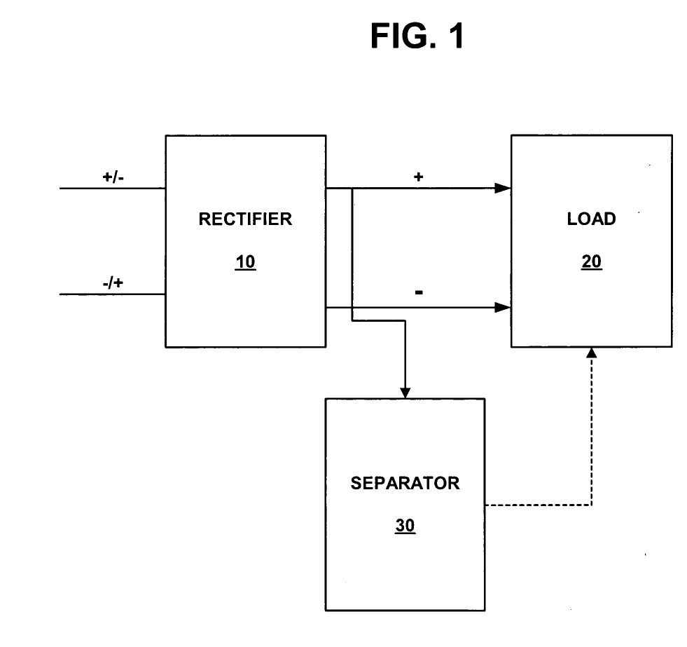

FIG. 1 is a high-level block diagram of a configuration including a rectifier 10 for supplying power to a load 20 and digital signals to a separator 30. The digital signals output by the separator 30 advantageously can be applied to control the load 20. The separator 30 can be, in an exemplary and non-limiting case, a high pass filter receiving digital data at a predetermined bias voltage level, e.g., the DC voltage of the power supplying the load 20. Alternatively, the separator can be an RS-232 decoder.

The digital data can be either digital control data or some other form of data, e.g., digital audio data. The digital signals, i.e., digital data applied to the load 20, can be a combination of several data types. For example, when the load 20 is a digital amplifier, the digital data advantageously can include both digital audio data to be processed by the digital amplifier and control signals determining the manner in which the digital amplifier processes the digital audio data. In several of the exemplary embodiments discussed herein, the digital data can be digital audio data conforming to the Sony/Philips Digital InterFace (S/PDIF) standard, a serial interface for transferring digital audio between devices, such as CD and DVD players, and amplifiers.

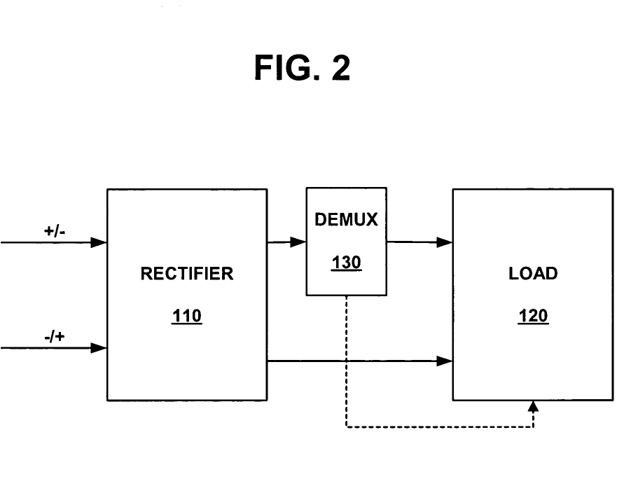

FIG. 2 is a high-level block diagram of a configuration including a rectifier 110 for supplying power to a load 120 and digital data to a demultiplexer 130. The digital data output by the demultiplexer 130 advantageously can be provided as digital data to an input terminal of the load 120.

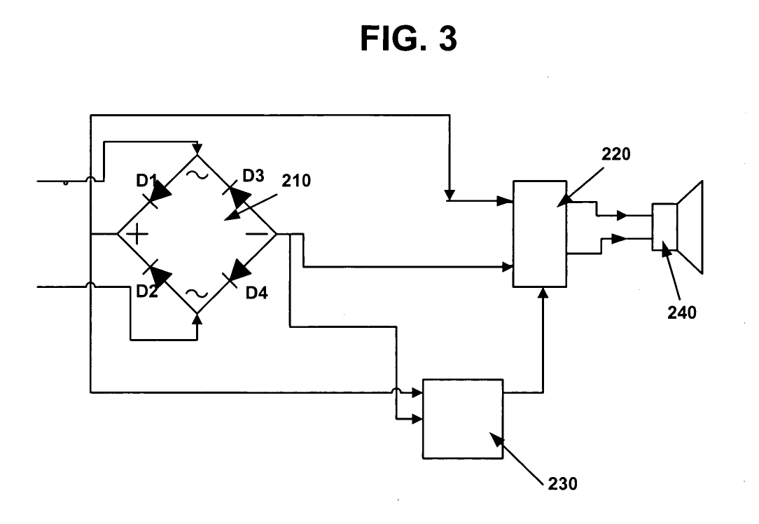

From the description of FIGS. 1 and 2 above, it will be appreciated that both power and the digital data superimposed and/or multiplexed on the incoming power signal are rectified by a rectifier 10 or 110 before being applied to the respective load 20 or 120. The rectifier advantageously ensures that the polarity of the voltage supplied to the load is proper, irrespective of the polarity of the voltage applied to the rectifier. Moreover, the rectifier advantageously ensures that the polarity of the digital data is also proper. The rectifier can be either the half-wave rectifier depicted in FIGS. 1 and 2 or a full-wave rectifier, as illustrated in FIGS. 3-6, which is discussed in greater detail below.

FIG. 3 is an illustration of a configuration including a full-wave bridge rectifier 210 supplying power to a load 220 and digital data to a decoder 230. In the exemplary and non-limiting configuration of FIG. 3, the load 220 advantageously can be a digital amplifier driving a speaker 240 in response to digital audio data (and possibly digital control signals) output by the decoder 230.

One exemplary circuit that can be employed as the decoder is either an RS-422 decoder or an RS-485 decoder. The RS-422 protocol provides a mechanism by which serial data can be transmitted over great distances (to 4,000 feet) and at very high speeds (up to 10 Mbps). This is accomplished by splitting each signal across two separate wires in opposite states, one inverted and one not inverted. The difference in voltage between the two lines is compared by the decoder, e.g., the decoder 230, to determine the logical state of the signal. This wire configuration, called differential data transmission or balanced transmission, is well suited to noisy environments. With balanced transmission, this potential difference will effect both wires equally, and thus not effect their inverse relationship. Twisted pairs of wire, which ensure that neither line is permanently closer to a noise source than the other, are often used to best equalize influences on the two lines. The RS-485 protocol is similar to the RS-422 protocol but permits a balanced transmission line to be shared in a party line or multidrop mode. Thus, as many as thirty two driver/receiver pairs can share a multidrop network.

In contrast, with the RS-232 communication scheme illustrated in FIGS. 1 and 2, which is unbalanced transmission and uses only one wire, signal degradation can take place if there is a difference in ground potential between the transmitting and receiving ends of the cable. However, this unbalanced transmission scheme is suitable for many applications.

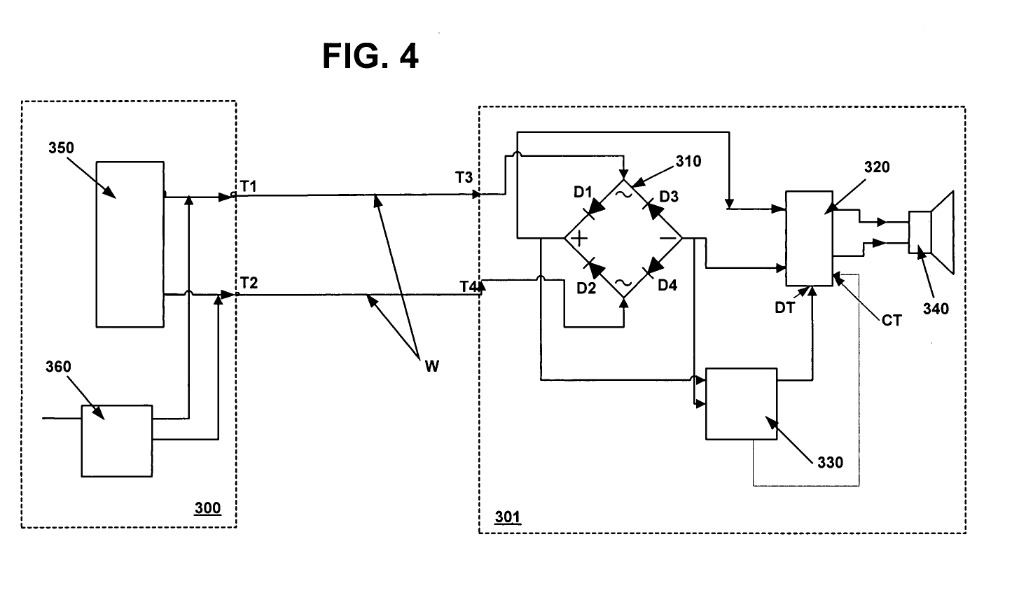

FIG. 4 is an illustration of a system employing the exemplary configuration illustrated in FIG. 3, wherein first and second devices 300 and 301 are coupled to one another by a wire pair (hereinafter wire) W. The wire W can be a twisted wire pair; the wire W can also be speaker wire.

The first device 310 can be a computer, or an audio or video player (e.g., a CD or DVD player), or a tuner, to list a few of the exemplary devices that can drive an exemplary speaker. The first device 310 includes a power supply 350 and an encoder 360. As mentioned above, the encoder 360 can be, in an exemplary case, an RS-232, an RS-422, or an RS-485 encoder. The system of FIG. 4 is not limited to serial digital data conforming to one of these enumerated protocols. The digital data generated by the encoder 360 is superimposed or impressed on the output of the power supply 350. The combined power and digital data are then output by the first device 300 at terminals T1 and T2.

The combined power and digital data output by the terminals T1 and T2 are applied to the input terminals T3 and T4 of the second device 301 via wire W. The combined signal is thus applied to the input terminals (denoted −) of rectifier 310. The combined power and digital data output by the terminals labeled + and − of the rectifier 310 are provided to a load 320 as well as a decoder 330. The decoder type is matched to the encoder type. In the exemplary configuration illustrated in FIG. 4, the load 320 drives a speaker 340. The second device 301 advantageously can be a powered speaker device.

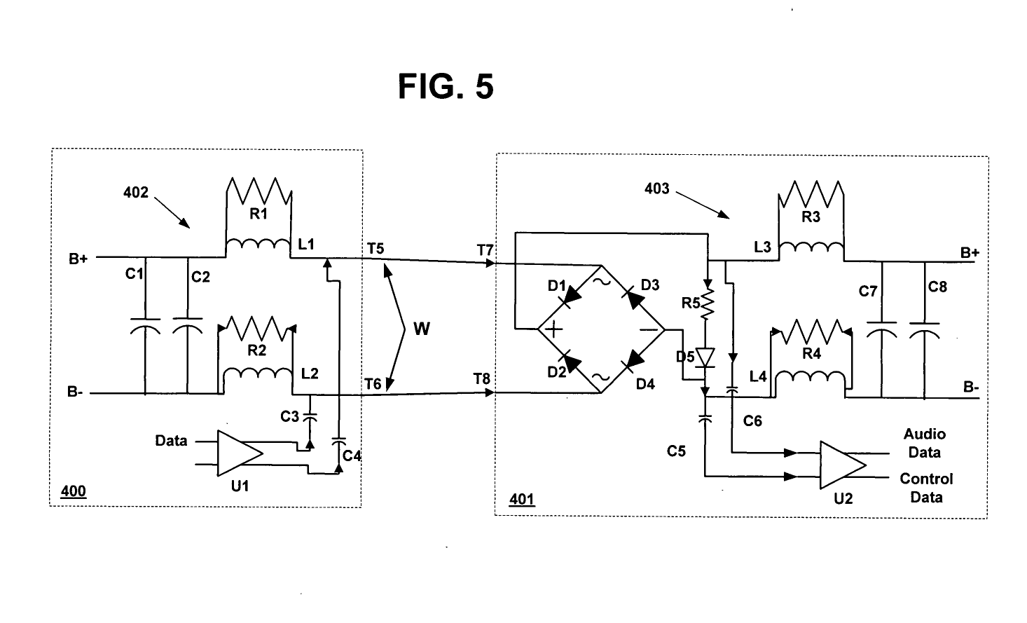

FIG. 5 is a schematic diagram depicting exemplary circuit elements for implementing the system depicted in FIG. 4. Front end 400, which advantageously can be disposed in, for example, a player, a tuner, or a computer, includes a filter assembly 402 providing filtered power to terminals T5 and T6 of front end 400. The filter assembly can, in the exemplary case illustrated in FIG. 5, include a pair of capacitors C1 and C2, which are disposed across a pair of power leads carrying potentials B+ and B−. These capacitors smooth out any transients in the applied DC voltage. Each leg of the transmission path coupled to terminals T5 and T6 includes an inductor (L1 or L2), which bucks or opposes line voltage transients generated when the digital data is impressed on these leads, and a pair of resistors (R1 and R2, respectively) disposed in parallel with the inductors L1 and L2. Resistors R1 and R2 facilitate impedance matching between the front end 400 and a back end 401.

Front end 400 also includes an encoder U1, which, in an exemplary and non-limiting case, can be an RS-422 or RS-485 encoder. Encoder U1 receives S/PDIF signals and generates differentially-encoded digital data, which is applied to terminals T5 and T6, in an exemplary case, via capacitors C3 and C4. Thus, combined power and digital data signals are output at terminals T5 and T6 of front end 400.

These combined power and digital data signals are applied to terminals T7 and T8 of back end 401 via wire W, e.g., speaker wire. The combined power and digital data is subsequently applied to the input terminals of the full-wave bridge rectifier formed by diodes D1-D4. The power output by the bridge rectifier is filtered by filter assembly 403, which, in an exemplary case, is a mirror image of the filter assembly 402. Thus, capacitors C7 and C8 eliminate transients in the output power, inductors L3 and L4 oppose voltage transients, and resistors R3 and R4 facilitate impedance matching with the front end 400. A resistor R5 serially coupled to a diode D5, ensures that the diodes D1-D4 in the bride rectifier are within their operating range. In an exemplary case, the diode D5 advantageously can be a light emitting diode (LED), which provides a positive indication that the circuitry in the back end 401 is operating properly.

A decoder U2, which is coupled to the outputs of the bridge rectifier formed by diodes D1-D4 via a pair of capacitors C5 and C6, recover the digital data, e.g., differentially-encoded data embedded in the combined power and digital data applied via the wire W. The output of decoder U2 is applied to a data terminal DT of the amplifier. See FIG. 4. In an exemplary case where both digital audio signals and control signals are recovered by the decoder U2 from the output of rectifier, the control signals advantageously can be applied to at least one control terminal CT of the amplifier, as illustrated in FIG. 4. It will be appreciated that the digital data, corresponding to both digital audio signals and control signals, advantageously can be applied to the amplifier 420, when the amplifier provides a function for differentiating audio data from control data.

The power applied via the wires W is DC power. In the exemplary case where a full-wave bridge rectifier such as that depicted in FIG. 5 is employed, the rectifier ensures that the polarity of the power applied to a load (See FIGS. 1-4 and 6.) has the desired polarity. Thus, irrespective of how the wires W are connected between the front end 400 and the back end 401, the polarity will always be correct. In cases where the polarity of some or all of the digital data signals is important, the polarity of the digital data will also be correct no matter how the wire W is strung between terminals T5-T6 and terminals T7-T8.

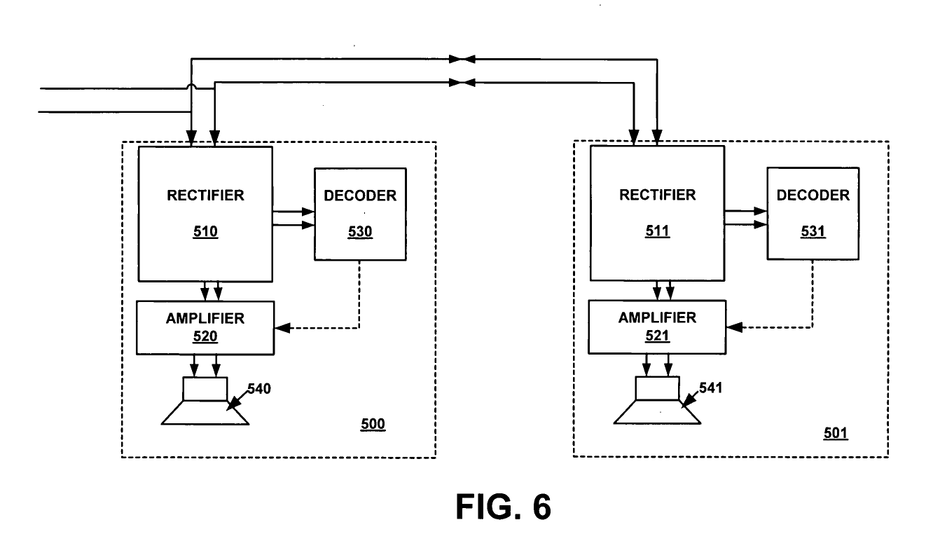

As mentioned above, the encoder-decoder pair employed, for example in the systems depicted in FIGS. 4 and 5, advantageously can follow the RS-485 protocol, which permits devices to be serially connected, i.e., daisy-chained to one another. FIG. 6 is a high-level block diagram of a speaker system employing the exemplary configuration of the present invention depicted in FIG. 3, wherein multiple powered speakers 500 and 501 are serially coupled to a front end device (not shown). The powered speaker 500 (501), in an exemplary case, includes a rectifier 510 (511), providing power to an amplifier 520 (521) and digital data to a decoder 530 (531). A speaker 540 (541) is operatively coupled to the amplifier 520 (521). Digital data recovered from the combined power and digital data applied via the wires W can be applied to the amplifier 520 (521).

Regarding the speaker system illustrated in FIG. 6, the digital data applied to the powered speaker 500 (501) advantageously can be digital audio data. More specifically, this digital audio data can be first and second digital audio data, e.g., left and right digital audio data in a stereo system or selected channel data in a 5.1 surround sound system. In the exemplary case, the decoder 530 recovers only the first digital audio data and provides a corresponding data stream to the amplifier 520 while the decoder 531 recovers only the second digital audio data and provides a corresponding data stream to the amplifier 521.

Thus, an apparatus according to the present invention provides an interface and corresponding method for providing both power and digital data to a device employing both types of signals over a pair of wires, e.g., zip cord, speaker wire, etc. A rectifier, which in an exemplary case can be a diode bridge rectifier, ensures that applied power has the desired polarity. When the digital data is polarity sensitive, the rectifier also ensures that the digital data has the correct polarity. Thus, irrespective of the way in which the combined power and digital data is applied to the rectifier, power and digital data having the correct polarity are output by the rectifier.

Moreover, the apparatus, when employed in a digital speaker, e.g., the powered speakers illustrated in FIGS. 3 and 6, permits the digital data to be provided at the point of application, i.e., at the data terminals of the digital amplifier. This avoids the signal degradation normally associated with CD players and the like where analog signals corresponding to the recorded digital data is employed to drive conventional speakers.

Finally, when the apparatus is employed in a digital speaker, the apparatus allows a person with little or no experience to connect the digital speakers to a digital data source. The connections are easier to make since the polarity of the digital speaker is independent of the polarity of the speaker wire employed in the connection. Such is not the case in analog systems, where reversing the polarity of one of several speakers could seriously degrade the sound quality of the overall system.

Although specific embodiments of the present invention have been described and illustrated, the present invention is not limited to the specific forms or arrangements of parts so described and illustrated. Instead, the present invention is construed according to the following claims.

1. Apparatus for receiving dc power and digital signals on a single wire pair, the apparatus comprising:
first means, responsive to power and the digital signals, for producing output power and output digital signals having a predetermined polarity; and
second means for detecting the digital signals having the predetermined polarity output by the first means.

2. The apparatus as recited in claim 1, wherein the digital signals having the predetermined polarity comprise digital audio signals.

3. The apparatus as recited in claim 1, wherein the digital signals having the predetermined polarity comprise digital audio signals and control signals.

4. The apparatus as recited in claim 1, wherein the second means comprises a high pass filter.

5. The apparatus as recited in claim 1, wherein:
the digital signals having the predetermined polarity comprise balanced digital signals; and
the second means comprises a differential detector.

6. The apparatus as recited in claim 1, wherein the first means comprises a rectifier.

7. The apparatus as recited in claim 6, wherein the rectifier comprises a full wave bridge rectifier.

8. The apparatus as recited in claim 1, wherein the first means comprises a demultiplexer.

9. An interface routing power and digital signals to a load, comprising:
a rectifier receiving the power and the digital signals over a single wire pair and producing rectified power and rectified digital signals for setting the polarity to the data signals; and
a separator for separating the rectified power driving the load from the rectified digital signals controlling output of the load.

10. The interface as recited in claim 9, wherein the rectified digital signals comprise rectified digital audio signals.

11. The interface as recited in claim 9, wherein the rectified digital signals comprise rectified digital audio signals and control signals.

12. The interface as recited in claim 9, wherein the load comprises an amplifier.

13. The interface as recited in claim 9, wherein the separator comprises a high pass filter.

14. The interface as recited in claim 9, wherein:
the rectified digital signals comprise balanced digital signals; and
the separator comprises a differential detector.

15. The interface as recited in claim 9, wherein the rectifier comprises a full wave bridge rectifier.

16. A speaker including an amplifier energized by rectified power and driven in response to rectified digital signals applied to the amplifier, the rectified power and rectified digital signals being provided to the speaker via the interface recited in claim 9.

17. The speaker as recite in claim 16, further comprising a filter network routing the rectified power to the amplifier.

18. A speaker system comprising first and second speakers, each of the first and second speakers including an amplifier energized by rectified power and driven in response to rectified digital signals applied to the amplifier, the rectified power and rectified digital signals being provided to each of the speakers via a respective interface as recited in claim 9.

19. The speaker system as recite in claim 18, wherein each of the speakers further comprises a filter network routing the rectified power to a respective amplifier.

20. A method for driving a powered load with digital signals over a two wire pair, comprising:
receiving power and the digital signals at input terminals of a rectifier;
rectifying both the power and the digital signals to thereby generate rectified power and rectified digital signals output at output terminals of the rectifier;
coupling the rectified power to power input terminals of the powered load;
generating digital data signals responsive to the rectified digital signals; and
applying the digital data signals to signal input terminals of the powered load to thereby drive the powered load.

21. The method as recited in claim 20, wherein:
the powered load further comprises a control signal input terminal,
the rectified digital signals comprise the digital data signals and digital control signals; and
the powered load operates on the digital data signals under control of the digital control signals applied to the control signal input terminal.

22. The method as recited in claim 21, wherein the digital data signals comprise digital audio signals.

23. The method as recited in claim 20, wherein the digital data signals comprise digital audio signals.
